(19) United States
(12) Patent Application Publication
(10) Pub. No.: US 2023/0320375 A1
(43) Pub. Date: Oct. 12, 2023

(54) SYSTEMS AND METHODS FOR RAPIDLY FREEZING A LIQUID

(71) Applicant: CORNELL UNIVERSITY, Ithaca, NY (US)

(72) Inventors: Syed S.H. RIZVI, Ithaca, NY (US); Richard HEBB, Orlando, FL (US)

(73) Assignee: CORNELL UNIVERSITY, Ithaca, NY (US)

(21) Appl. No.: 18/023,357

(22) PCT Filed: Aug. 31, 2021
(86) PCT No.: PCT/US2021/048398

§ 371 Date: Feb. 25, 2023

Related U.S. Application Data
(60) Provisional application No. 29/777,194, filed on Apr. 3, 2021.
(60) Provisional application No. 63/072,593, filed on Aug. 31, 2020.

(51) Int. Cl. A23G 9/06; A23G 9/20; A23G 9/22

(52) U.S. Cl. CPC A23G 9/06; A23G 9/20; A23G 9/228

(57) ABSTRACT

A system and method for rapidly preparing ice cream or other frozen food/beverage products at a point-of-sale/consumption is provided. For example, the apparatus and method are suited to freeze liquid ice cream mix and distribute it at a predetermined temperature and with a smooth consistency and texture.

This application claims the benefit of U.S. Provisional Patent Application Ser. No. 63/072,593, filed Aug. 31, 2020, and U.S. Design Application Ser. No. 29/777,194, filed Apr. 3, 2021, the entire disclosures of each are incorporated by reference herein.

### FIELD OF THE INVENTION

Embodiments of the present invention are generally related to systems and methods for rapid freezing of consumable and non-consumable products. One embodiment of the present invention is a system that employs an eductor nozzles to freeze liquids, such as ice cream mixes, on demand.

### BACKGROUND OF THE INVENTION

Conventional ice cream production generally employs scrape-and-churn techniques, where a liquid ice cream mix is pumped through a drum-shaped heat exchanger. Vaporizing refrigerant (at approximately −30° C.) in a jacket surrounding the heat exchanger barrel allows for energy transfer out of the mix, resulting in the formation of ice crystals. Ice cream production systems can be constructed as batch or continuous operations, and the ice cream is usually drawn from the drum in a partially frozen state so that it is still flowable. Many variations of these types of systems are commercially available, and all require a lot of time, energy, and potentially dangerous chemical refrigerant (such as ammonia) to produce ice cream. The scrape and churn process relies on the economy of scale to be profitable, and therefore only large batches of a single flavor can be produced easily and a large apparatus is required. Rapid customization of ice cream products is difficult or impossible.

Traditional traditional systems use rotating blades to scrape ice crystals from the internal surface of the heat exchanger. The ice crystals are moved to the center of the freezer barrel where the ice crystals grow to a mean size of 30-35 μm. The rotating blades continuously scrape the freezing ice cream from the cold drum walls into a bulk of the ice cream mix. During the agitation process, the ice cream mix is cooled as evenly as possible to avoid ice crystal agglomeration that would hamper ice cream product quality and impede freezing. Agitation also introduces air into the mix. Pressurized air can also be introduced into the freezer to aid in whipping, which increases “overrun,” i.e., an increase of the ice cream specific volume when compared to the liquid ice cream mix. The entrained air also improves product creaminess, smoothness, and mouthfeel.

One drawback of traditional systems is that the blades used to agitate ice cream in the scrape-and-churn method are necessarily complex in shape and have significant surface area. Thus, ice cream will often stick to the blades during the scrape and churn process, resulting in substantial product waste. Another drawback is that typical scrape-and-churn ice cream freezing methods are also inherently slow because of the time required to cool and freeze aqueous mixtures, even though the freezing must be done as rapidly as possible to help keep ice crystals from growing large and negatively impacting the product quality.

Furthermore, the scrape-and-churn method produces unfinished, partially-frozen ice cream (like soft-serve) that must be subjected to a second time- and energy-consuming process known as “hardening” before the finished ice cream can be shipped or stored stably. Hardening is a process wherein the ice cream product of the scrape-and-churn method is placed in a blast freezer or hardening tunnel—typically held at −30 to −40C—to freeze most of the liquid water that remains in the ice cream after the scrape-and-churn process. After hardening, the completely frozen ice cream product must be stored at or below −25C to prevent ice crystal growth and agglomeration. The ice cream must also be kept cold between the scrape-and-churn process and consumer delivery. As one of ordinary skill in the art will appreciate, the need for a refrigerated supply chain from production to consumption requires an enormous amount of energy.

Some products and methods attempt to solve some of the problems addressed by embodiments of the disclosed invention. For example, U.S. Pat. No. 7,754,266 discloses an invention that rapidly prepares ice cream by mixing liquid ice cream mix and a liquified gas (nitrogen) in a specialized blender without the use of dangerous refrigerant chemicals. However, the disclosed invention requires that a specific and pre-measured volume of liquid ice cream mix be manually added for each serving of ice cream product. In addition, a mixing blade is employed to agitate the liquid ice cream mix during its freezing and, thus, this invention suffers the drawbacks of product loss and potential agglomeration inherent to the scrape and churn method.

Similarly, U.S. Published Patent Application No. 2009/0120305 discloses an invention for preparing ice cream by mixing liquid ice cream mix with liquified gas in an open vessel, ideally a specialized blender, without the use of chemical refrigerant. This invention suffers the drawbacks of the '266 Patent, plus the disclosed process is manual and requires an employee/operator. As will be appreciated upon review of the following description of embodiments of the instant invention, after an initial set up by an employee/operator, the present invention can function independently as a kiosk at the point of sale/consumption until its CO2 or liquid ice cream mix supplies need refilling.

PCT Patent Application Publication WO2004098308 discloses an invention for preparing frozen ice cream that employs a circulating refrigerant to cool a plate and a “scrape and roll” method. The liquid ice cream mix is placed on the cooling plate and begins to freeze. The freezing ice cream is then scraped off the cooling plate with a specialized scraper and rolled into a roll shape. The scraper is driven automatically using hydraulics or other means. Therefore, a means to rapidly produce single servings of a product similar to conventional ice cream is provided, but this reference does not teach how to incorporate air or any other gas into the ice cream product. The method and apparatus described in the '308 publication relies on a chemical refrigerant and requires two different fluids to motivate freezing and movement of the liquid ice cream. Movement is motivated by connecting a compressed gas source (e.g., oxygen or CO2) to the liquid ice cream mix to effectively blow the liquid onto the cooling plate. Freezing is then motivated by heat exchanged with the chemical refrigerant through the cooling plate. Furthermore, scraping requires an additional hydraulic fluid system or some other means of automation.

PCT Patent Application Publication No. WO2016079641 discloses an invention comprising a small scrape-and-churn ice cream maker intended for use in homes, restaurants, bars, etc. The disclosed invention obviates the need for refrigerated storage/transport of ice cream by producing at the point of sale or consumption, but it still requires at least 20 minutes to produce at most 1000 g of ice cream. Therefore, it does not rapidly produce ice cream; it is dependent on chemical refrigerant and is subject to the same inherent drawbacks as any other scrape-and-churn method.

Finally, European Patent Application Publication No. EP1450318 discloses an invention that can be characterized as a coin-operated soft-serve ice cream machine. After an initial setup by an employee/operator, the invention can function independently as a kiosk at the point of sale until its liquid ice cream mix supplies are exhausted. The invention, however, relies on chemical refrigerants. While the disclosed device dispenses ice cream on demand, it does not produce ice cream on demand; therefore, energy must be applied to refrigerate the ice cream product between its production and sale.

Thus, it is a long-felt need in the preparation of cold consumer products, such as ice cream, to provide an energy-efficient system that can produce the desired product quickly. The foregoing disclosure describes an improved system and method for quickly chilling premade liquefied mixes to a predetermined temperature for consumption.

### SUMMARY OF THE INVENTION

It is one aspect of some embodiments the present invention to provide a system that receives liquid ice cream mix at or about room temperature and outputs ice cream in less than about five seconds. The contemplated system produces ice cream with very small ice crystals and a smooth texture.

To achieve this functionality, one embodiment uses an eductor, i.e., a device that uses kinetic energy from a motive fluid to create a pressure differential in a confined space that draws a second fluid to a mixing zone. The eductor may be comprised of two symmetrically arranged suction ports that provide fluid tangentially. In one embodiment, the motive fluid is carbon dioxide and the second fluid is liquid ice cream mixture. Although one embodiment of the present invention uses carbon dioxide, those of ordinary skill in the art will appreciate that other motive fluids, either liquids or gases, can be used without departing from the scope of the invention. Incorporating carbon dioxide into the frozen ice cream product instead of air creates a unique taste experience reminiscent of a carbonated beverage. Indeed, a carbonated beverage, such as beer or soda, can be used as a fluid to be frozen. As the eductor provides a large pressure gradient, the liquid ice cream mix moves through the system without the need for additional pumps or scrapers.

The contemplated eductor has a small external envelope, so exposure to the freezing ice cream is limited, which reduces the amount of product wasted due to sticking to the cold educator. As mentioned above, this is a drawback with traditional scrape-and-churn systems, wherein blades must be cleaned periodically to ensure room temperature material is mixed with chilled material. The contemplated system includes components that are easily disassembled and cleaned. Further, the components are made of stainless steel or other hygienic, food-grade material, wherein no pipe threads are employed or exposed to the liquid ice cream mixture or final product.

An added benefit of employing a small educator is that the entire system may be used in homes, restaurants, or bars. Further, the system may be incorporated into a small self-serve kiosk. In some embodiments, the stock liquids are shelf-stable and do not require refrigeration.

In some embodiments, one or more ingredients (e.g., a liquid ice cream mix, etc.) may require refrigeration and the kiosk may accordingly comprise a refrigeration system for such one or more ingredients that are not shelf stable. Such a kiosk would be simpler and manufacture and more efficient to operate. Furthermore, the contemplated kiosk may include openings that allow consumers to insert their own flavors and additions to the base ice cream mix, which will be discussed below. In some embodiments, the kiosk is configured to dispense a single type or flavor of ice cream, chilled confection, and/or frozen precursor (e.g., a frozen product to which ingredients may be added in a separate step), whereas, in other embodiments, the kiosk is configured to dispense a plurality (two, three, four, . . . n, where n is any integer) of types or flavors of ice cream, chilled confection, and/or frozen precursor. For instance, in some embodiments, the kiosk may possess the ability to output different types of ice cream (e.g., vanilla or chocolate, vanilla, chocolate or, strawberry, etc.). In one embodiment, the kiosk comprises a communication interface connectable to a communication pathway (e.g., a wireless internet connection, etc.) and can communicate with a consumer's mobile device or a computer, wherein the consumer makes advanced or real-time orders. Of course, the systems and components thereof are scalable can be made larger to accommodate larger serving sizes for bulk production.

It is another aspect of embodiments of the present invention to provide a system that allows for customization of the final ice cream product. That is, because the ice cream may be made for a customized sale, the vendor can add any desired add-ins to a single-serving batch being delivered to the customer. Any liquid ice cream mix of any flavor or flavors can be frozen in a single serving batch within seconds, inclusions such as chocolate chips, chocolate syrup, peanut butter, cherries, mint, cookies, cannabis, ground coffee beans, frozen coffee crystals, etc. can be added manually immediately after production or integrated into the production process. Further, although ice cream has been described primarily herein, those of ordinary skill in the art will appreciate that the novel systems, methods, devices, and technologies described herein can be applied to any liquid intended to be chilled or frozen. For example, sorbet sherbet, gelato, frozen slush, frozen alcoholic drinks, and other common, semi-frozen, or frozen foodstuffs or drinks can be produced by embodiments of the present invention. Indeed, some of the contemplated systems employ the means by which fried ice cream can be quickly made. In one embodiment, the feed liquid is water that system chills and freezes to form a clathrate composed of water ice and carbon dioxide containing trapped/dissolved CO2. The clathrate can be used to generate cold carbonated water. Because of its low thermal conductivity, the clathrate may also slow ice melt and, thus, provide a prolonged cooling effect, e.g., for use in medical applications.

It is another aspect of some embodiments, the present invention to provide a system that does not use harmful refrigerants to maintain the liquid ice cream mix or end product at the desired temperature. As one of ordinary skill in the art will appreciate, omitting the use of harmful chemicals is desirous for environmental concerns. In addition, omitting the use of chemical refrigerants is cost-effective as they are very expensive and are subject to regulatory control. In addition, as the contemplated system employs rapid freezing techniques, wherein the ice cream mix may be stored at room temperature or modestly refrigerated, on-demand production at the point-of-sale is possible. This aspect relieves the need for refrigerated shipping, which reduces production and supply chain costs. For example, the system's feed may comprise pasteurized shelf-stable ice cream mix that eliminates the need for refrigeration at any point in the production chain. In other embodiments, powdered (e.g., dewatered) mix is used that is later hydrated with water, coffee, or other liquid. Because the ice cream is produced at the point-of-sale, there is no need to harden the ice cream before shipment, which significantly reduces the energy required to produce the final ice cream product.

The aspects and embodiments of the present invention described herein can be combined with the teachings of U.S. Pat. No. 10,624,363, the entirety of which is incorporated by reference herein.

It is one aspect of some embodiments of the present invention to provide a system for freezing a liquid, comprising: a liquid container in fluidic communication with an eductor assembly, the eductor assembly comprising: an acceleration duct having at least one liquid inlet, a mixing zone interconnected to the acceleration zone, a freezing zone interconnected to the freezing zone, and a nozzle associated with the acceleration duct at an end opposite the mixing zone, wherein a nozzle outlet is located in the acceleration duct and positioned above the mixing zone; a pressurized gas supply system, comprising: a gas supply, a compressor pump associated with the gas supply, the pump configured to pressurize gas drawn from the gas supply and deliver pressurized gas to a high pressure vessel that is in fluidic communication with the nozzle of the eductor assembly; a collection container adjacent to an outlet of the freezing zone; and wherein the liquid is draw into the eductor assembly when the pressurized gas is directed through the nozzle, wherein a portion of the pressurized gas is mixed with the liquid, and wherein the freezing zone is configured to create a localized low pressure area that freezes the liquid and gas mixture to produce an at least frozen material.

It is another aspect of some embodiments of the present invention to provide a system for freezing a liquid, comprising: a liquid container; an eductor assembly in fluidic communication with the liquid container, the eductor assembly comprising: an acceleration duct having at least one liquid inlet, a mixing zone interconnected to the acceleration zone, a freezing zone interconnected to the freezing zone, and a nozzle associated with the acceleration duct at an end opposite the mixing zone, wherein a nozzle outlet is located in the acceleration duct and positioned above the mixing zone; a pressurized gas supply system configured to selectively deliver pressurize gas to the eductor assembly; and a frozen product collection container configured to receive frozen material from an output of the eductor assembly.

It is still yet another aspect of some embodiments of the present invention to provide a system for freezing a liquid, comprising: a liquid supply container in fluidic communication with a liquid container; an eductor assembly in fluidic communication with the liquid container; a pressure vessel adapted to contain a gas at a predetermined pressure, the pressure vessel in communication with the educator assembly; a frozen product collection container configured to receive frozen material from an output of the eductor assembly; wherein the gas is CO2 and liquid stored in the liquid supply container is at least one liquid ice cream mix; and wherein the eductor assembly comprises: a first inlet and a second inlet that are in fluidic communication with the liquid container and that are interconnected to a body having a generally cylindrical outer profile, wherein the first inlet and second inlet interconnect to the body generally tangentially to the outer profile, a nozzle in fluidic communication with the pressure vessel; an acceleration duct defined by an annulus positioned between an outer surface of the nozzle and an inner surface of the body; a mixing zone in fluidic communication with the acceleration duct configured to receive and mix the liquid ice cream and CO2 to form a product; a freezing zone in fluidic communication with the mixing zone configured to receive the product and reduce the temperature thereof, thereby forming the frozen product; and a frozen product ejection outlet in fluidic communication with the frozen product collection container.

It is another aspect of some embodiments of the present invention to provide an apparatus for preparing a consumable frozen product, comprising: (a) an ejector venturi system comprising: (i) a housing, (ii) an outer surface and an inner surface, (iii) an interior cavity, (iv) at least one port adapted for releasing a pressurized fluid into the interior cavity, said at least one port extending from the outer surface to the interior cavity, and having a nozzle positioned within the interior cavity, wherein the nozzle is configured to release pressurized fluid through the nozzle to produce negative pressure that allows the pressurized fluid to expand within the interior cavity, and (v) at least one channel interconnected tangentially to the housing adapted for introducing a liquid consumable product into the interior cavity, wherein the at least one channel positioned proximate to the nozzle so that the negative pressure produced by the expanding pressurized fluid creates suction on the at least one channel sufficient to draw the liquid consumable product into the interior cavity without the need of gravity or positive pressure; (b) at least one valve coupled to the at least one port for regulating passage of the pressurized fluid into the interior cavity; and (c) at least one valve coupled to the first end of the at least one channel, for regulating the flow of the liquid consumable product, the second end of the at least one channel positioned proximate to the at least one port on the inner surface of the housing, wherein when the at least one valve coupled to the at least one port and the at least one valve coupled to the first end of the at least one channel are open, the liquid consumable product contacts the stream of expanding pressurized fluid within the interior cavity.

It is still yet another aspect of some embodiments of the present invention to provide a method of producing a consumable frozen product, comprising: providing an ejector venturi system comprising: a housing, an outer surface and an inner surface, an interior cavity, at least one port adapted for releasing a pressurized fluid into the interior cavity, said at least one port extending from the outer surface to the interior cavity, and having a nozzle positioned within the interior cavity, and at least one channel interconnected tangentially to the housing that is adapted for introducing a liquid consumable product into the interior cavity, wherein the at least one channel positioned proximate to the nozzle so that the negative pressure produced by the expanding pressurized fluid creates suction on the at least one channel sufficient to draw the liquid consumable product into the interior cavity without the need of gravity or positive pressure; providing at least one valve coupled to the at least one port for regulating passage of the pressurized fluid into the interior cavity; and providing at least one valve coupled to the first end of the at least one channel, for regulating the flow of the liquid consumable product, the second end of the at least one channel positioned proximate to the at least one port on the inner surface of the housing, wherein when the at least one valve coupled to the at least one port and the at least one valve coupled to the first end of the at least one channel are open, the liquid consumable product contacts the stream of expanding pressurized fluid within the interior cavity; releasing a pressurized fluid into the ejector venturi system, wherein the releasing of the pressurized fluid through the nozzle creates negative pressure and the pressurized fluid expands within the interior cavity, thereby causing a rapid drop in temperature of the expanding pressurized fluid; and drawing a liquid consumable product into the interior cavity of the ejector venturi system through the at least one channel so that the liquid consumable product contacts a stream of the expanding pressurized fluid within the interior cavity, thereby yielding the consumable frozen product, wherein the negative pressure produced by the expanding pressurized fluid creates suction on the at least one channel sufficient to draw the liquid consumable product into the interior cavity without the need of gravity or positive pressure, wherein the flow of the liquid consumable product is regulated by at least one valve coupled to the first end of the at least one channel, wherein when the pressurized fluid is released and the liquid consumable product is drawn into the interior cavity of the ejector venturi system, the liquid consumable product is atomized into droplets upon contact with the expanding pressurized fluid and the atomized droplets are frozen.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium”, as used herein, refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms “determine”, “calculate” and “compute,” and variations thereof, as used herein, are used interchangeably and include any type of methodology, process, mathematical operation or technique.

The term “module”, as used herein, refers to any known or later developed hardware, software, firmware, artificial intelligence, fuzzy logic, or combination of hardware and software that is capable of performing the functionality associated with that element.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a schematic of the system of one embodiment of the present invention.

FIG. 2 is a partial cross-sectional view of an educator assembly of one embodiment of the present invention.

FIG. 3 shows the dimensions of the eductor of one embodiment of the present invention. Those of ordinary skill in the art will appreciate that other dimensions and configurations are possible, and the dimensions provided are for reference only.

FIG. 4 is a top cross-sectional view of the eductor shown in FIG. 3.

FIG. 5 is a schematic of a system of another embodiment of the present invention.

FIG. 6 is a depiction of feeding ports employed by one embodiment of the present invention.

FIG. 7 is an example communications/data processing network system that may be used in conjunction with embodiments of the present invention.

FIG. 8 is an example computer system that may be used in conjunction with embodiments of the present invention.

The following component list and associated numbering found in the drawings is provided to assist in the understanding of one embodiment of the present invention:

| # | Component |
|---|---|
| 2 | System |
| 4 | Serving size liquid container |
| 6 | Eductor assembly |
| 20 | Feedline |
| 22 | Frozen product collection container |
| 40 | High-pressure CO2 supply system |
| 44 | CO2 supply cylinder |
| 48 | Gas compressor pump |
| 52 | High pressure vessel |
| 56 | Back pressure regulator (BPR) |
| 60 | Forward pressure regulator (FPR) |
| 64 | CO2 valve, automatic |
| 70 | One-way valve |
| 80 | Liquid supply container |
| 84 | Liquid valve, automatic |
| 88 | Load sensor |
| 90 | Ventilated space |
| 94 | Frozen product |
| 98 | External ventilation system |
| 102 | Perforated shelf |
| 302 | CO2 nozzle |
| 304 | Nozzle outlet |
| 306 | Acceleration duct |
| 310 | Liquid inlet |
| 314 | Liquid inlet outer surface |
| 318 | Acceleration duct outer surface |
| 322 | Internal volume |
| 326 | Acceleration duct inner surface |
| 330 | CO2 |
| 334 | Mixing zone |
| 338 | Freezing zone |
| 342 | Outlet |
| 346 | Lip |
| 402 | System |
| 403 | Serving size container |
| 404 | Vent valve |
| 406 | Eductor assembly |
| 408 | Liquid valve |
| 412 | Gas source |
| 464 | CO2 valve |
| 466 | CO2 valve |
| 484 | Liquid valve |
| 502 | Manifold |
| 506 | Fluid inlet |
| 510 | Valve |
| 514 | Valve |
| 600 | System |
| 600 | System |
| 605 | User computer |
| 610 | User computer |
| 615 | User computer |
| 620 | Network |
| 625 | Server |
| 630 | Server |
| 635 | Database |
| 700 | Computer system |
| 705 | CPU |
| 710 | Input device |
| 715 | Output device |
| 720 | Storage device |
| 725 | Storage media reader |
| 730 | Communications system |
| 735 | Processing acceleration |
| 740 | Working memory |
| 745 | Operating system |
| 750 | Other code |
| 755 | Bus |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Embodiments of the present invention consists of a system 2 for suctioning liquid ice cream mix, or any other liquid to be frozen, from a serving sized liquid container 4 into an eductor assembly 6 (e.g., Venturi, jet siphon, etc.) that accelerates the liquid in a liquid acceleration zone, mixes the liquid with high velocity/high-pressure gas or liquid in the mixing zone, freezes the liquid in a freezing zone, and subsequently deposits frozen product into a frozen product collection container 22. In one embodiment the gas or liquid is high-pressure CO2 directed through a CO2 nozzle, wherein a high-velocity general CO2 is formed at a nozzle outlet that creates a low-pressure region inside the eductor assembly 6 that acts as the motivation for suction (i.e., the Bernoulli effect). The temperature of the CO2 drops almost instantly as it accelerates through the nozzle and he pressurizes (i.e., Joule-Thompson cooling), wherein the CO2 temperature at the nozzle outlet is typically −77° C. or less. The cold CO2, therefore, freeze the ice cream mix.

In one embodiment, the liquid ice cream mix is frozen and ready to eat in about 5 seconds. The rapid mixing and freezing results in a smooth ice cream product. Mixing the CO2 during freezing also incorporates CO2 from the nozzle into the frozen product in a manner analogous to the incorporation of air by the scrape and churn methods described above. In one embodiment, the amount of pressurized gas dissolved in the ice cream is about 10-100% of the volume of the ice cream mix.

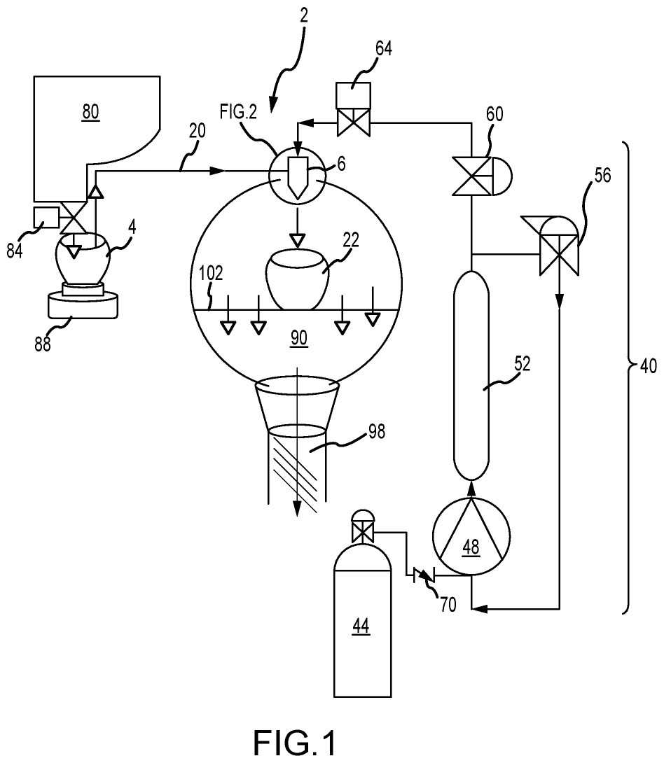

FIG. 1 shows a system of one embodiment where high-pressure carbon dioxide is supplied to the CO2 nozzle by a high-pressure CO2 supply system 40. The system 40 of one embodiment consists of a CO2 supply cylinder 44, a gas compressor pump 48, a high-pressure vessel 42, a back pressure regulator (BPR) 56, a forward pressure regulator (FPR) 60, and an automatic CO2 valve 64. CO2 is supplied to the gas compressor pump 48 from the CO2 cylinder 44. The gas compressor pump is driven by compressed air from an external compressed air supply that compresses the supplied CO2 to increase CO2 pressure. The gas compressor pump 4 forces the compressed CO2 into the high-pressure vessel 52. In one embodiment, the CO2 pressure in the high-pressure vessel is maintained higher than the desired CO2 pressure at the CO2 nozzle of the eductor assembly 6, and heat is supplied to the high-pressure vessel 52 to prevent its temperature from decreasing during prolonged periods of ice cream production.

Those of ordinary skill in the art will appreciate that the CO2 supply cylinder 44 (e.g., a 60 L cylinder, a 5 lb cylinder, a 10 lb cylinder, a 15 lb cylinder, 20 lb cylinder, 35 lb cylinder, 50 lb cylinder, etc.) may comprise a stand-alone cylinder that can be periodically recharged or replaced. Some embodiments of the present invention contemplate the use of small, home-use CO2 supply cylinders that are regularly filled with CO2 and incorporated into the contemplated system. In other embodiments, larger CO2 supply cylinders are utilized. Some embodiments of the present invention employ a heat source (e.g., heat tracing, etc.) to increase the temperature of the CO2 supply cylinder 44, which increases the pressure of the stored CO2, alone or in conjunction with the gas compressor pump 48. Further, heating the gas supply cylinder 44 may be required in larger systems to maximize the amount of CO2 taken from the CO2 supply cylinder 44. Regardless of the size of the system, a temperature-controlled, high-pressure CO2 supply cylinder 44 serves as a source of motive and cooling fluid, wherein cylinder temperature is automatically increased to compensate for loss or pressure associated with each ice cream producing blast, which will be described below.

The CO2 in the high-pressure vessel 52 is in fluid communication with the inlets of both the FPR 60 and the BPR 56. The BPR 56 allows an operator to set a maximum pressure for high-pressure vessel 52. If the CO2 pressure in the high-pressure vessel 52 exceeds the maximum pressure set point, the BPR 56 will allow CO2 to overflow from the high-pressure vessel 52 to an inlet of the gas compressor pump 48. A one-way valve 70 prevents the effluent from the BPR 56 from returning to the CO2 supply cylinder. Therefore, the CO2 pressure at the pump inlet will be higher than the CO2 pressure in the CO2 supply cylinder 44 when overflow occurs, preventing additional CO2 from the supply cylinder 44 from entering the system 40. Accordingly, the pump 48 can continue the cycle, but the mass of CO2 in the high-pressure vessel 44 will not increase and, thus, the pressure will not increase (for a given temperature). The FPR 60 allows an operator to set a desired CO2 pressure for the CO2 nozzle of the eductor assembly 62 any desired pressure set point below the pressure of the high-pressure vessel 44.

The FPR 60 allows CO2 to flow from the high-pressure vessel 44 to an inlet of the automatic CO2 valve 64 until the pressure at the outlet of the CO2 valve 64 reaches the desired nozzle pressure set point. The BPR FPR may be automatically or mainly operated. When the automatic CO2 valve 64 is open, pressure-regulated CO2 flows through the FPR 62 to the CO2 nozzle. Again, heat may be supplied to the pressure-regulated CO2 flow to prevent high-pressure CO2 supply system 40 from decreasing in temperature during prolonged operation. The automatic CO2 valve 64 is closed until CO2 pressure behind the valve 64 reaches the desired nozzle pressure set point and the liquid ice cream is ready in the serving size container 4. The CO2 valve 64 can then be prompted by the user/customer/operator to open and expel CO2 for a precise, predetermined time and automatically close. The user/customer/operator may adjust this “blast-time” to modify the product's portion size and/or temperature. Portion size adjustments also require adjustments to the liquid ice cream mass readied in the serving size container 4 as described below.

In one embodiment, the pressure set point for the BPR 56 is about 1300 psi, and therefore the CO2 pressure in the high-pressure vessel 44 is at most 1300 psi. The pressure set point for the FPR 60 is about 1050 psi, and therefore the pressure at the CO2 nozzle of the eductor assembly 6 is about 1000-3000 psi, preferably about 1050-1250 psi. In one embodiment, the temperature of the CO2 supply system 40 about 35 C, which is maintained by two separate thermostat-controlled heaters; one applied to the high-pressure vessel 44 and the other applied to the connections between the outlet of the FPR 60 and the nozzle of the eductor assembly 6.

The size and pressure rating of the high-pressure vessel and the pump rate of the CO2 compressor pump 48 determines the maximum blast time length. Typically, the mass flow of CO2 exiting the nozzle during the blast time exceeds the CO2 pump rate and, therefore, the pressure in the high-pressure vessel 44 decreases. If the falling pressure in the vessel 44 decreases below the FPR's pressure set point, the CO2 pressure behind the nozzle will fall, and both suction and cooling power will diminish. Thus, the maximum length of the blast time may be increased by either providing a fast pumping apparatus or by increasing the available mass of compressed CO2 in the high-pressure vessel 44. The available mass of compressed CO2 may be increased by providing a larger high-pressure vessel or by increasing the pressure set point for the high-pressure vessel. The fast pumping apparatus would supply compressed CO2 at a rate equivalent to or greater than the mass flow rate of CO2 exiting the nozzle during a blast. The fast pumping apparatus would also allow for continuous, uninterrupted operation.

In one embodiment, an electrically controlled FPR can be used and a microprocessor of a control system can control the FPR's set point. One of ordinary skill in the art will appreciate the control system may employ temperature and/or pressure sensors. The contemplated control system is configured to direct the opening and closing of the valves described herein. A temperature sensor can also be located in the serving-size container to report the temperature of the liquid ice cream mix to the microprocessor. The microprocessor can then adjust the FPR pressure set point to an optimal CO2 pressure that corresponds to the specific measured liquid temperature. This can standardize the temperature of the product even if the temperature of the input liquid varies.

In one embodiment, the liquid ice cream mix is supplied to the serving size liquid container 4 by a system consisting of a liquid supply container 80, an automatic liquid valve 84, and an optional load sensor 88. The liquid supply container 80 may be large enough to hold many multiples servings of ice cream mix. When prompted by the user/customer/operator, the automatic liquid valve 84 opens to dispense liquid ice cream into the serving size container 2, which may be located on the load sensor 88.

The automatic liquid valve 84 is prompted to close once the mass in the serving size container 4, as reported by the load sensor 88, reaches a predetermined cutoff mass value. Alternatively, a pre-metered amount in a pre-packaged container may be used to supply liquid ice cream mix, or liquid ice cream mix can be added manually. The preferred input temperature of the liquid ice cream mix is about 20° C. Other temperatures greater than 0° C. are also acceptable. A user/customer/operator may adjust the mass of the serving size portion by adjusting the cutoff mass value and/or the blast time. In one embodiment, the user/customer/operator may choose between multiple predetermined serving size options (e.g., small, medium, large), and a processor automatically adjusts the blast time length and the cutoff mass value to preprogrammed values that reflect the predetermined serving size option.

In one embodiment, the product collection container 22 is located in an enclosed and ventilated space 90 so that CO2 not captured in the mix vents after it is used to motivate, mix, and freeze the ice cream. The product collection container 22 can be configured to receive additional toppings or foodstuffs before or after the receipt of the ice cream. Some embodiments, frozen product 94 exiting the ejection outlet of the eductor assembly 6, which will be described below, is slowed before it enters the collection container 22. An external ventilation system 98 may be associated with the ventilated space 90. Alternatively, the system is operated outdoors and the ventilated space 90 is open to the atmosphere. In either case, the product collection container is placed on a perforated shelf 102 so access CO2 proceeds out of the ventilated space 90 after motivating, mixing, and freezing the ice cream.

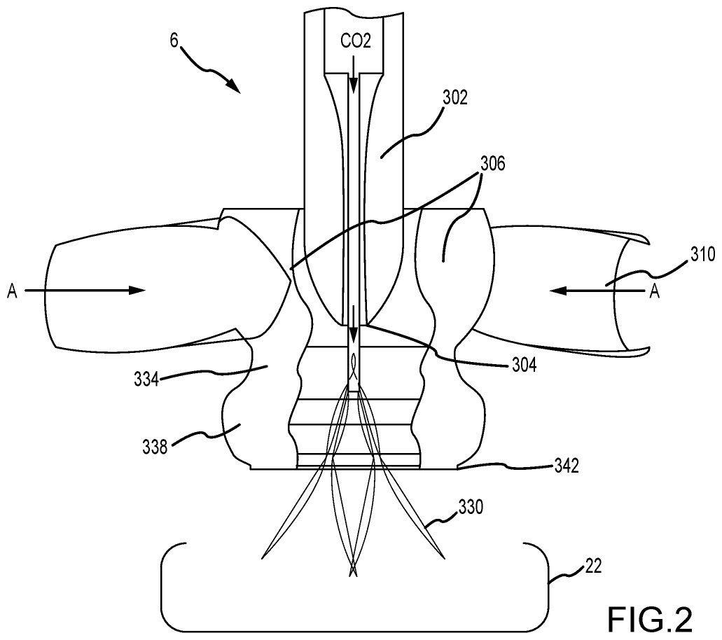

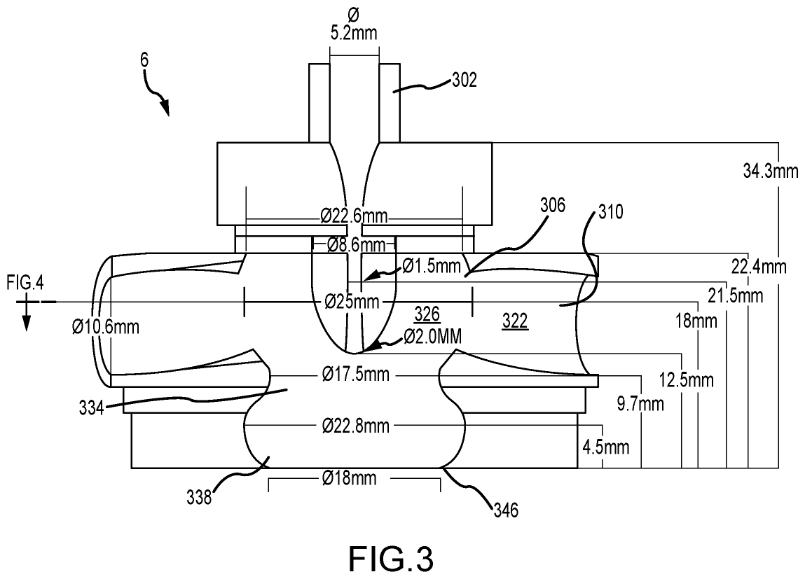

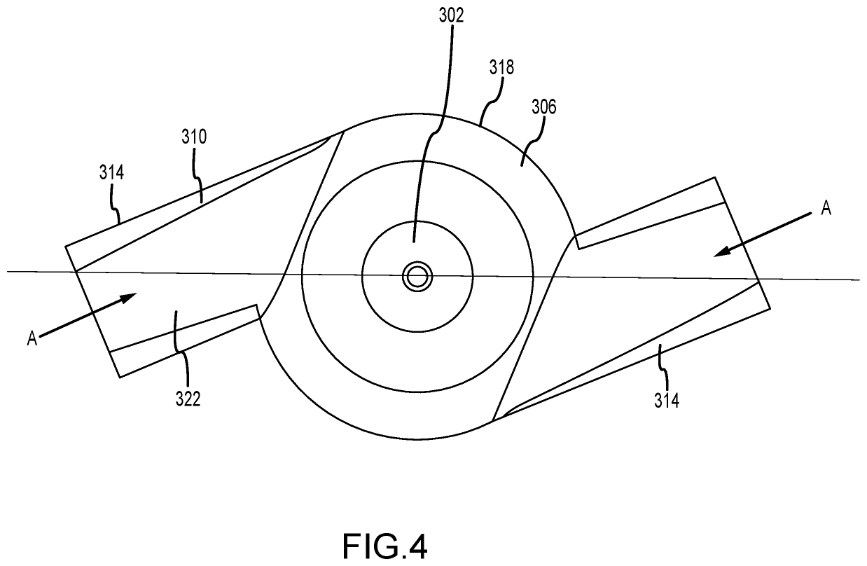

FIGS. 2-4 show and eductor assembly 6 of one embodiment of the present invention that generally consists of the CO2 nozzle 302 described above inserted into an acceleration duct 306. The CO2 nozzle 302 includes an outlet 304 positioned within the acceleration duct 306. The acceleration duct 306 has a generally circular or toroidal outer profile interconnected to first and second liquid inlets 310. The liquid inlets 310 receive fluid from the serving size liquid container by one or more feed lines (see, FIG. 1, reference number 20). As shown in FIG. 4, the liquid inlets 310 are tangentially interconnected to the acceleration duct 306. Stated differently, an outer surface 314 of the liquid inlet 310 defines a tangent of the outer surface 318 of the acceleration duct 306. Accordingly, the internal volume 322 of the liquid inlets 310 direct fluid tangentially to the acceleration duct's internal, toroidal internal surface 326, generally along arrow arrows A.

In operation, high pressure and high-velocity CO2 traveling through the CO2 nozzle 302 creates a low-pressure zone in the acceleration duct 306 that draws liquid fluid mix into the acceleration duct. As mentioned above, the fluid enters the acceleration duct 306 tangentially and accelerates around the CO2 nozzle 302 with high linear and rotational velocities before mixing with the CO2 expelled from the CO2 nozzle 330. One of ordinary skill in the art will appreciate that the highest CO2 velocity and, thus, the highest mode of suction occurs adjacent to the nozzle outlet 304. Positioned below the acceleration duct 306 is a mixing zone 334 where liquid ice cream is atomized by the high-velocity CO2 jet 330. The mixing zone's diameter is reduced to increase vacuum pressure. A freezing zone 338 is located beneath the mixing zone 334 and possesses an increased internal diameter that reduces or prevents freezing ice cream mix blockage. The expansion provided by the freezing zone 38 also reduces pressure and temperature and slows the mixed materials while they are freezing. Finally, an outlet 342 is provided that may possess a sharply-angled lip 346 that helps ensure the effluxing fluids proceeds downward into the collection container 22 instead of adhering to the eductor assembly 6.

In one embodiment, the acceleration duct, mixing zone, freezing zone, frozen product ejection outlet, and CO2 nozzle are made of stainless steel and interconnected by a threadless, quick disconnect fitting to allow for easy assembly/disassembly and maintenance. In one embodiment, these components are produced by Direct Metal Laser Sintering (DMLS), a 3D printing manufacturing technique capable of producing parts in food-grade stainless steel.

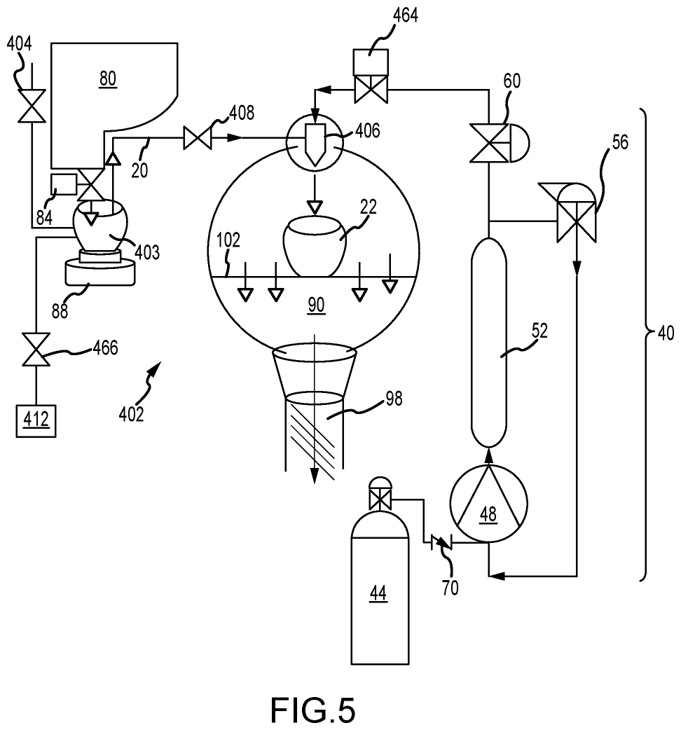

FIG. 5 shows another embodiment of the contemplated system 402 intended to increase product overrun. Here, the serving size container 403 is initially sealed to maintain its internal pressure and an automatically operated vent valve 404 is provided. A second automatic liquid valve 408 is located between the serving size container 403 and the eductor assembly 406. The second automatic valve 408 opens and closes in synchrony with the CO2 valve 464. Further, a gas at moderate pressure 412 (e.g., CO2 at about 15 to 400 psi) is connected to the serving size container via a second automatic CO2 valve 466.

In operation, ice cream production proceeds by opening the first liquid valve 484 to dispense the serving of liquid ice cream mix into the serving size container (e.g., a 3 ounce, 5 pounds, 8 ounce, or 12 ounce container). The first liquid valve 44 is closed after the serving has been dispensed in the serving size container 403. Next, the second CO2 valve 466 automatically opens, wherein the moderately pressure gas enters the serving size container 403, which increases the internal pressure in the serving size container to a point equal to that of the moderately pressure gas. Because the serving size container is sealed, some amount of the moderately pressurized gas dissolves into the liquid ice cream mix. Ice cream is produced in a fashion similar to that described above wherein the first CO2 valve 464 and the second liquid valve 408 automatically open at the same time and liquid is suctioned from the serving size container 403 into the eductor assembly 406. One primary difference from the process described above is that the moderately pressure gas continues to flow into the serving size container 403 when the first liquid valve and CO2 valve are opened. Again, pressure exerted on the liquid ice cream mix will decrease as it accelerates through the eductor assembly, expanding the CO2 dissolved in the liquid ice cream mix and increasing product overrun. The primary CO2 valve 464, secondary CO2 valve 466, and a liquid valve 488 automatically close after a predetermined blast time. Finally, the vent valve 404 on the serving size container 403 automatically opens until the container's internal pressure becomes gauge, which signals the vent valve to close.

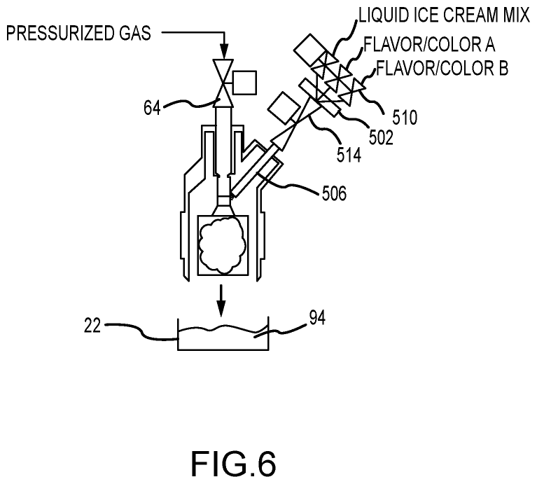

FIG. 6 is a general schematic of one embodiment of the present invention that includes a manifold 502 configured to add different flavorings/colorings to the ice cream mix 2, thus, provide options to make different ice cream types. One of ordinary skill in the art will appreciate that the manifold 502 is in fluidic communication with at least one of the liquid inlets 306 of the eductor assembly described above. One of ordinary skill in the art should also appreciate that the features of FIG. 6 may be applied to the eductor configuration shown above. The manifold 502 is associated with a plurality of valves 510 that selectively open to allow flavorings/colorings to enter the manifold 502. The manifold may also be interconnected to the inlet with a valve 514. The manifold and associated valves may be interconnected to the eductor assembly 6 by quick-disconnect fittings that allow for efficient disassembly, cleaning, and reassembly.

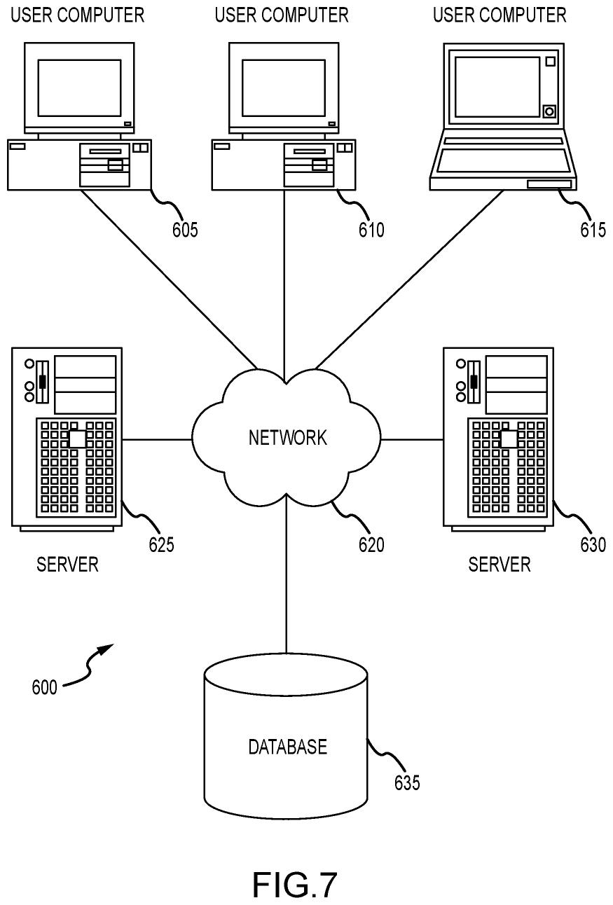

Referring to FIG. 7, an example network system is provided that may be used in connection with the communication aspects disclosed herein. Those of ordinary skill in the art will appreciate that some of all of the aspects disclosed herein may be employed by the control system mentioned above. More specifically, FIG. 7 illustrates a block diagram of a system 600 that may use a web service connector to integrate an application with a web service. The system 600 includes one or more user computers 605, 610, and 615. The user computers 605, 610, and 615 may be general purpose personal computers (including, merely by way of example, personal computers and/or laptop computers running various versions of Microsoft Corp.'s Windows® and/or Apple Corp.'s Macintosh® operating systems) and/or workstation computers running any of a variety of commercially-available UNIX® or UNIX-like operating systems. These user computers 605, 610, and 615 may also have any of a variety of applications, including for example, database client and/or server applications, and web browser applications. Alternatively, the user computers 605, 610, and 615 may be any other electronic device, such as a thin-client computer, Internet-enabled mobile telephone, and/or personal digital assistant, capable of communicating via a network (e.g., the network 620 described below) and/or displaying and navigating web pages or other types of electronic documents. Although the exemplary system 600 is shown with three user computers, any number of user computers may be supported.

System 600 further includes a network 620. The network 620 may be any type of network familiar to those skilled in the art that can support data communications using any of a variety of commercially-available protocols, including without limitation TCP/IP, SNA, IPX, AppleTalk, and the like. Merely by way of example, the network 620 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth© protocol known in the art, and/or any other wireless protocol); and/or any combination of these and/or other networks.

The system 600 may also include one or more server computers 625, 630. One server may be a web server 625, which may be used to process requests for web pages or other electronic documents from user computers 605, 610, and 615. The web server can be running an operating system including any of those discussed above, as well as any commercially-available server operating systems. The web server 625 can also run a variety of server applications, including HTTP servers, FTP servers, CGI servers, database servers, Java servers, and the like. In some instances, the web server 625 may publish operations available as one or more web services.

The system 600 may also include one or more file and/or application servers 630, which can, in addition to an operating system, include one or more applications accessible by a client running on one or more of the user computers 605, 610, and 615. The server(s) 130 may be one or more general purpose computers capable of executing programs or scripts in response to the user computers 605, 610, and 615. As one example, the server may execute one or more web applications. The web application may be implemented as one or more scripts or programs written in any programming language, such as Java™, C, C® or C++, and/or any scripting language, such as Perl, Python, or TCL, as well as combinations of any programming/scripting languages. The application server(s) 630 may also include database servers, including without limitation those commercially available from Oracle, Microsoft, Sybase™, IBM™ and the like, which can process requests from database clients running on a user computer 605.

In some embodiments, an application server 630 may create web pages dynamically for displaying the development system. The web pages created by the web application server 630 may be forwarded to a user computer 105 via a web server 625. Similarly, the web server 625 may be able to receive web page requests, web services invocations, and/or input data from a user computer 605 and can forward the web page requests and/or input data to the web application server 630.

In further embodiments, the server 630 may function as a file server. Although for ease of description, FIG. 7 illustrates a separate web server 625 and file/application server 630, those skilled in the art will recognize that the functions described with respect to servers 605, 610, and 615 may be performed by a single server and/or a plurality of specialized servers, depending on implementation-specific needs and parameters.

The system 600 may also include a database 635. The database 635 may reside in a variety of locations. By way of example, database 635 may reside on a storage medium local to (and/or resident in) one or more of the computers 605, 610, 615, 625, 630 105, 110, 115, 125, 130. Alternatively, it may be remote from any or all of the computers 605, 610, 615, 625, 630, and in communication (e.g., via the network 120) with one or more of these. In a particular set of embodiments, the database 635 may reside in a storage-area network (“SAN”) familiar to those skilled in the art. Similarly, any necessary files for performing the functions attributed to the computers 605, 610, 615, 625, 630 may be stored locally on the respective computer and/or remotely, as appropriate. In one set of embodiments, the database 635 may be a relational database, such as Oracle 10i®, that is adapted to store, update, and retrieve data in response to SQL-formatted commands.

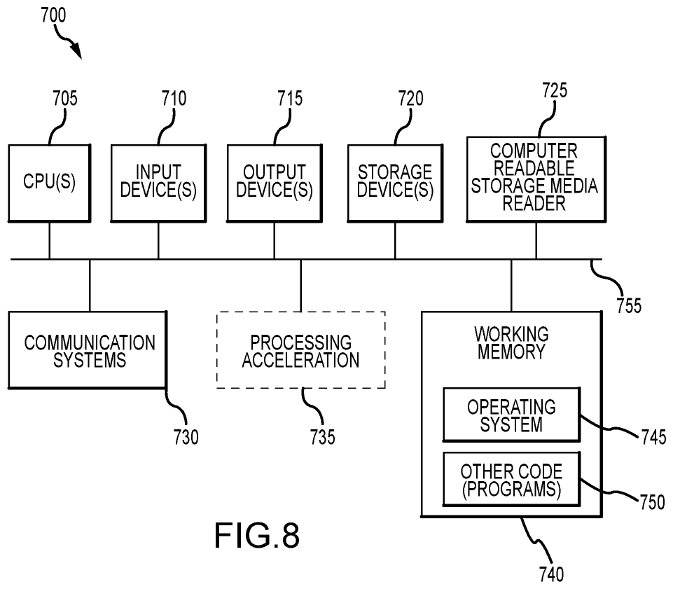

Referring to FIG. 8, an example computer system is provided that may be used in connection with the communication aspects disclosed herein. Those of ordinary skill in the art will appreciate that some of all of the aspects disclosed herein may be employed by the control system mentioned above. More specifically, FIG. 8 illustrates one embodiment of a computer system 700 upon which a web service connector or components of a web service connector may be deployed or executed. The computer system 700 is shown comprising hardware elements that may be electrically coupled via a bus 755. The hardware elements may include one or more central processing units (CPUs) 705; one or more input devices 710 (e.g., a mouse, a keyboard, etc.); and one or more output devices 715 (e.g., a display device, a printer, etc.). The computer system 700 may also include one or more storage device 770. By way of example, storage device(s) 720 may be disk drives, optical storage devices, solid-state storage device such as a non-transitory memory device, a random access memory (“RAM”), and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735, which can include a DSP, a special-purpose processor and/or the like.

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with the network 720 and/or any other computer described above with respect to the system 700.

The computer system 700 may also comprise software elements, shown as being currently located within a working memory 740, including an operating system 745 and/or other code 750, such as program code implementing a web service connector or components of a web service connector. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

It should be appreciated that the methods described herein may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A system for freezing a liquid, comprising:
a liquid container in fluidic communication with an eductor assembly, the eductor assembly comprising:
an acceleration duct having at least one liquid inlet,
a mixing zone interconnected to the acceleration zone,
a freezing zone interconnected to the freezing zone, and
a nozzle associated with the acceleration duct at an end opposite the mixing zone, wherein a nozzle outlet is located in the acceleration duct and positioned above the mixing zone;
a pressurized gas supply system, comprising:
a gas supply,
a compressor pump associated with the gas supply, the pump configured to pressurize gas drawn from the gas supply and deliver pressurized gas to a high pressure vessel that is in fluidic communication with the nozzle of the eductor assembly;
a collection container adjacent to an outlet of the freezing zone; and
wherein the liquid is draw into the eductor assembly when the pressurized gas is directed through the nozzle, wherein a portion of the pressurized gas is mixed with the liquid, and wherein the freezing zone is configured to create a localized low pressure area that freezes the liquid and gas mixture to produce an at least frozen material.

2. The system of claim 1, wherein the at least one liquid inlet comprises a first liquid inlet and a second liquid inlet, the fluid inlets configured to deliver fluid into the acceleration duct tangentially with respect to an inner surface of the acceleration duct such that potion of the accelerated fluid rotates about the nozzle.

3. The system of claim 1, wherein the mixing zone has an inner surface with an outer extent less that an outer extent of an inner surface of the freezing zone, which defines a contraction that produces a low pressure area.

4. The system of claim 1, wherein the collection container rests on a perforated shelf, and is positioned in a ventilated space associated with a ventilation system configured to remove excess gas from the system.

5. The system of claim 4, wherein the excess gas is vented to atmosphere or directed to the gas supply.

6. The system of claim 1, wherein the liquid container is a manifold configured to receive the liquid and at least one additional liquid and/or additive.

7. The system of claim 1, further comprising a second gas supply in fluidic communication with the liquid container configured to pre-pressurize the liquid, wherein the pre-pressurized liquid is drawn into the eductor assembly, mixed with high pressure gas, and expanded in the freezing zone.

8. The system of claim 7, wherein the first gas supply is CO2 or O2 and the second gas supply is CO2, O2, or N2.

9. A system for freezing a liquid, comprising:
a liquid container;
an eductor assembly in fluidic communication with the liquid container, the eductor assembly comprising:
an acceleration duct having at least one liquid inlet,
a mixing zone interconnected to the acceleration zone,
a freezing zone interconnected to the freezing zone, and
a nozzle associated with the acceleration duct at an end opposite the mixing zone, wherein a nozzle outlet is located in the acceleration duct and positioned above the mixing zone;
a pressurized gas supply system configured to selectively deliver pressurize gas to the eductor assembly; and
a frozen product collection container configured to receive frozen material from an output of the eductor assembly.

10. The system of claim 9, wherein the eductor assembly is devoid of pumps.

11. The system of claim 9, wherein the liquid container and eductor assembly are devoid of external refrigeration means.

12. The system of claim 9, further comprising a liquid supply container interconnected to the liquid container, a load sensor configured to detect the weight of the liquid container and material therein, and a valve integrated into a feed line that connects the liquid supply container and the liquid container, wherein the valve is configured to communicate with the load sensor to initiate closure of the valve when material in the liquid container reaches a predetermined weight.

13. The system of claim 12, wherein the gas is CO2 and liquid stored in the liquid supply container is at least one liquid ice cream mix.

14. The system of claim 9, further comprising a reservoir in communication with the frozen product collection container, the reservoir configured to store and selectively disperse at least one liquid or foodstuff into the frozen material.

15. The system of claim 9, wherein the pressurized gas supply system comprises a pressure vessel adapted to contain a gas at a predetermined pressure that is in fluidic communication with the eductor assembly, pressure vessel is also in fluidic communication with a gas supply cylinder or gas generator.

16. The system of claim 15, wherein the gas generator produces nitrogen.

17. The system of claim 15, wherein the pressurized gas supply system further comprises:
a forward pressure regulator located between the pressure vessel and the eductor assembly;
a compressor interconnected to the pressure vessel between the gas supply cylinder or gas generator and the pressure vessel;
a back pressure regulator associated with outlet of the pressure vessel, which is positioned on an end of the forward pressure regulator opposite the eductor assembly, and an inlet of the compressor;
wherein the gas in the high-pressure vessel is in fluid connection with inlets of the forward-pressure regulator and the back-pressure regulator;
wherein if the gas pressure in the pressure vessel exceeds a maximum-pressure set point, the back pressure regulator allows gas to flow from the pressure vessel to the compressor; and
wherein the forward pressure regulator is configured to allow an operator to set a predefined gas pressure to be received by the eductor assembly.

18. The system of claim 9, further comprising a CO2 ventilation area bounded on one end by a perforated shelf configured to allow excess CO2 to pass therethrough and an external ventilation system configured to expel excess CO2.

19. The system of claim 18, further comprising a CO2 detection system associated with the CO2 ventilation area that sounds an alarm and ceases CO2 flow from the high pressure tank when sensed CO2 exceeds a predetermined level.

20. A system for freezing a liquid, comprising:
a liquid supply container in fluidic communication with a liquid container;
an eductor assembly in fluidic communication with the liquid container;
a pressure vessel adapted to contain a gas at a predetermined pressure, the pressure vessel in communication with the educator assembly;
a frozen product collection container configured to receive frozen material from an output of the eductor assembly;
wherein the gas is CO2 and liquid stored in the liquid supply container is at least one liquid ice cream mix; and
wherein the eductor assembly comprises:
a first inlet and a second inlet that are in fluidic communication with the liquid container and that are interconnected to a body having a generally cylindrical outer profile, wherein the first inlet and second inlet interconnect to the body generally tangentially to the outer profile,
a nozzle in fluidic communication with the pressure vessel;
an acceleration duct defined by an annulus positioned between an outer surface of the nozzle and an inner surface of the body;
a mixing zone in fluidic communication with the acceleration duct configured to receive and mix the liquid ice cream and CO2 to form a product;
a freezing zone in fluidic communication with the mixing zone configured to receive the product and reduce the temperature thereof, thereby forming the frozen product; and
a frozen product ejection outlet in fluidic communication with the frozen product collection container.

21. An apparatus for preparing a consumable frozen product, comprising:
(a) an ejector venturi system comprising:
(i) a housing,
(ii) an outer surface and an inner surface,
(iii) an interior cavity,
(iv) at least one port adapted for releasing a pressurized fluid into the interior cavity, said at least one port extending from the outer surface to the interior cavity, and having a nozzle positioned within the interior cavity, wherein the nozzle is configured to release pressurized fluid through the nozzle to produce negative pressure that allows the pressurized fluid to expand within the interior cavity, and
(v) at least one channel interconnected tangentially to the housing adapted for introducing a liquid consumable product into the interior cavity, wherein the at least one channel positioned proximate to the nozzle so that the negative pressure produced by the expanding pressurized fluid creates suction on the at least one channel sufficient to draw the liquid consumable product into the interior cavity without the need of gravity or positive pressure;
(b) at least one valve coupled to the at least one port for regulating passage of the pressurized fluid into the interior cavity; and
(c) at least one valve coupled to the first end of the at least one channel, for regulating the flow of the liquid consumable product, the second end of the at least one channel positioned proximate to the at least one port on the inner surface of the housing, wherein when the at least one valve coupled to the at least one port and the at least one valve coupled to the first end of the at least one channel are open, the liquid consumable product contacts the stream of expanding pressurized fluid within the interior cavity.

22. The apparatus of claim 21, further comprising a high pressure gas storage container engaged with the ejector venturi system.

23. The apparatus of claim 21, wherein at least one valve coupled to the at least one port is a timed solenoid valve, and wherein at least one valve coupled to the first end of the at least one channel is a timed solenoid valve.

24. The apparatus of claim 24, wherein the nozzle and the at least one channel of the ejector venturi system are positioned relative to one another so that the liquid consumable product contacts the pressurized fluid at the vena contracta of the pressurized fluid as it expands in the interior cavity.

25. A method of producing a consumable frozen product, comprising:
providing an ejector venturi system comprising:
a housing,
an outer surface and an inner surface,
an interior cavity,
at least one port adapted for releasing a pressurized fluid into the interior cavity, said at least one port extending from the outer surface to the interior cavity, and having a nozzle positioned within the interior cavity, and
at least one channel interconnected tangentially to the housing that is adapted for introducing a liquid consumable product into the interior cavity, wherein the at least one channel positioned proximate to the nozzle so that the negative pressure produced by the expanding pressurized fluid creates suction on the at least one channel sufficient to draw the liquid consumable product into the interior cavity without the need of gravity or positive pressure;
providing at least one valve coupled to the at least one port for regulating passage of the pressurized fluid into the interior cavity; and
providing at least one valve coupled to the first end of the at least one channel, for regulating the flow of the liquid consumable product, the second end of the at least one channel positioned proximate to the at least one port on the inner surface of the housing, wherein when the at least one valve coupled to the at least one port and the at least one valve coupled to the first end of the at least one channel are open, the liquid consumable product contacts the stream of expanding pressurized fluid within the interior cavity;
releasing a pressurized fluid into the ejector venturi system, wherein the releasing of the pressurized fluid through the nozzle creates negative pressure and the pressurized fluid expands within the interior cavity, thereby causing a rapid drop in temperature of the expanding pressurized fluid; and
drawing a liquid consumable product into the interior cavity of the ejector venturi system through the at least one channel so that the liquid consumable product contacts a stream of the expanding pressurized fluid within the interior cavity, thereby yielding the consumable frozen product, wherein the negative pressure produced by the expanding pressurized fluid creates suction on the at least one channel sufficient to draw the liquid consumable product into the interior cavity without the need of gravity or positive pressure, wherein the flow of the liquid consumable product is regulated by at least one valve coupled to the first end of the at least one channel, wherein when the pressurized fluid is released and the liquid consumable product is drawn into the interior cavity of the ejector venturi system, the liquid consumable product is atomized into droplets upon contact with the expanding pressurized fluid and the atomized droplets are frozen.

26. The method of claim 25, wherein the pressurized fluid is pressurized between 500 psig and 5000 psig or between about 1000 psig and 5000 psig.

27. The method of claim 25, wherein the size of the frozen atomized droplets are between 20-100 microns, between about 20-90 microns, between about 20-80 microns, between about 20-70 microns, between about 20-60 microns, or less than 50 microns.

28. The method of claim 25, wherein the consumable frozen product is selected from the group consisting of ice cream, gelato, frozen yogurt, sherbet, frozen coffee beverage, frozen alcoholic beverage, and flavored frozen beverage.

29. A consumable frozen product produced according to the method of claim 25.

30. The consumable frozen product of claim 29, wherein the pressurized fluid used in the method is carbon dioxide so that the consumable frozen product comprises the carbon dioxide and is fizzy.
